(19) United States
(12) Patent Application Publication
(10) Pub. No.: US 2012/0327849 A1
(43) Pub. Date: Dec. 27, 2012

(54) METHOD FOR CONTROLLING NETWORK CONNECTION OF WIRELESS NETWORK DEVICE AND ASSOCIATED WIRELESS NETWORK DEVICE

(76) Inventors: Yung-Sen Lin, New Taipei City (TW); Tzu-Lung Chuang, New Taipei City (TW)

(21) Appl. No.: 13/417,324

(22) Filed: Mar. 12, 2012

Related U.S. Application Data
(60) Provisional application No. 61/500,623, filed on Jun. 24, 2011.

(30) Foreign Application Priority Data
Dec. 9, 2011 (TW) 100145525

(51) Int. Cl. H04W 48/20

(52) U.S. Cl. 370/328

(57) ABSTRACT

A method for controlling a network connection of a wireless network device includes: after the wireless network device is waked up from a sleep mode: loading a wireless network driver; determining whether a predetermined access point satisfies a predetermined rule under a condition that the wireless network driver does not scan access points; and when the predetermined access point satisfies the predetermined rule, the wireless network driver directly utilizes pre-stored network connection information to connect to the predetermined access point without scanning the access points.

### CROSS REFERENCE TO RELATED APPLICATIONS

This application claims the priority of U.S. Provisional Application No. 61/500,623, filed Jun. 24, 2011, which is included herein by reference in its entirety.

### BACKGROUND OF THE INVENTION

1. Field of the Invention

The present invention relates to a method for controlling a network connection of a wireless network device, and more particularly, to a method for controlling a wireless network device to quickly establish a link after being waked up from a sleep mode and an associated wireless network.

2. Description of the Prior Art

When a notebook or other mobile communication device enters a sleep mode, its network will be disconnected to save power. Then, after the notebook is waked up from the sleep mode, the network connection is re-established. During the re-establishment process, the notebook needs to scan all the neighboring access points, and these neighboring access points are compared to select one access point to establish a link. However, because these steps require 1-8 seconds, the user needs to waste a longer time to begin to use the network.

### SUMMARY OF THE INVENTION

It is therefore an objective of the present invention to provide a method for controlling a wireless network device to quickly establish a link after being waked up from a sleep mode and an associated wireless network, to solve the above-mentioned problem.

According to one embodiment of the present invention, a method for controlling a network connection of a wireless network device comprises: after the wireless network device is waked up from a sleep mode: loading a wireless network driver; determining whether a predetermined access point satisfies a predetermined rule under a condition that the wireless network driver does not scan access points; and when the predetermined access point satisfies the predetermined rule, the wireless network driver directly utilizes pre-stored network connection information to connect to the predetermined access point without scanning the access points.

According to another embodiment of the present invention, a wireless network device comprises a storage unit and a network component, where the storage unit stores an operating system and a wireless network driver. After the wireless network device is waked up from a sleep mode, the operating system resumes and loads the wireless network driver; the wireless network driver determines whether a predetermined access point satisfies a predetermined rule under a condition that the wireless network driver does not scan access points; and when the predetermined access point satisfies the predetermined rule, the wireless network driver directly utilizes pre-stored network connection information to connect to the predetermined access point via the network component without scanning the access points.

According to another embodiment of the present invention, a method for controlling a network connection of a wireless network device comprises: after the wireless network device is waked up from a sleep mode: loading a wireless network driver; scanning neighboring access points to obtain a plurality of access points by the wireless network driver; comparing the plurality of access points with an access point preferred list by the wireless network driver; when the wireless network driver receives a command from an operating system to ask for scanning the neighboring access points, and at least a portion of access points are in the access point preferred list, only responding the portion of access points to the operating system by the wireless network driver; and choosing one access point among the portion of access points, and sending the chosen access point to the wireless network driver by the operating system to establish a link.

According to another embodiment of the present invention, a wireless network device comprises a storage unit and a network component, where the storage unit stores an operating system and a wireless network driver. After the wireless network device is waked up from a sleep mode, the operating system loads a wireless network driver; the wireless network driver scans neighboring access points to obtain a plurality of access points; the wireless network driver compares the plurality of access points with an access point preferred list; when the wireless network driver receives a command from an operating system to ask for scanning the neighboring access points, and at least a portion of access points are in the access point preferred list, the wireless network driver only responds the portion of access points to the operating system; and the operating system chooses one access point among the portion of access points, and sends the chosen access point to the wireless network driver to establish a link via the network component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless network device according to one embodiment of the present invention.

FIG. 2 is a flowchart of a method for controlling a network connection of the wireless network device before the wireless network device enters a sleep mode according to one embodiment of the present invention.

FIG. 3 is a flowchart of the method for controlling the network connection of the wireless network device after the wireless network device wakes up from the sleep mode according to one embodiment of the present invention.

FIG. 4 is a flowchart of a detail of the Step S304 shown in FIG. 3.

FIG. 5 is a diagram illustrating timing of the operating steps of the operating system, wireless network driver and network component shown in FIG. 4.

FIG. 6 is a diagram illustrating a wireless network device according to another embodiment of the present invention.

FIG. 7 is a flowchart of a method for controlling a network connection of the wireless network device according to another embodiment of the present invention.

FIG. 8 is a flowchart of a detail of the Step S704 shown in FIG. 7.

FIG. 9 is a diagram illustrating timing of the operating steps of the operating system, wireless network driver and network component shown in FIG. 8.

### DETAILED DESCRIPTION

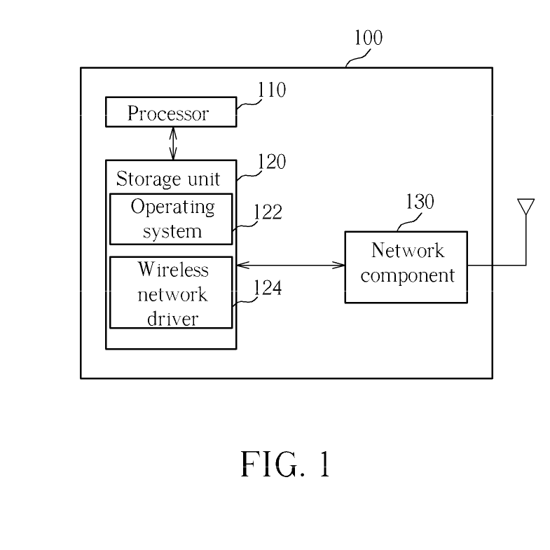

Please refer to FIG. 1, which illustrates a wireless network device 100 according to one embodiment of the present invention. As shown in FIG. 1, the wireless network device 100 includes a processor 110, a storage unit 120 and a network component 130, where the storage unit 120 stores an operating system 122 and a wireless network driver 124. In addition, in this embodiment, the wireless network device 100 can be a notebook, a tablet computer or any other mobile communication device having wireless network function.

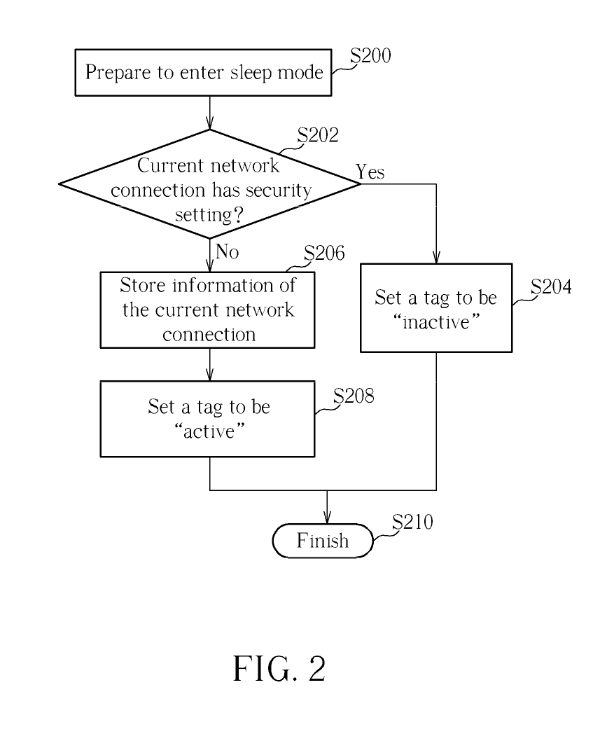

Please refer to FIG. 1 and FIG. 2 together. FIG. 2 is a flowchart of a method for controlling a network connection of the wireless network device 100 before the wireless network device 100 enters a sleep mode according to one embodiment of the present invention. It is noted that the “sleep mode” in the specification includes standby mode, hibernate mode or any other mode which can save power. In the sleep mode, a portion of operations of the wireless network device 100 are stopped, and the wireless network is disconnected. In addition, the flow shown in FIG. 2 is for illustrative purposes only, provided the results are substantially the same, the steps are not limited to be executed according to the exact order shown in FIG. 2. Referring to FIG. 2, the flow is described as follows.

In Step S200, the wireless network device 100 prepares to enter the sleep mode. Then, in Step S202, the wireless network driver 124 checks whether a current network connection has a security setting or not, that is, the wireless network driver 124 checks if the current connected access point requires a password to establish a link. If the current network connection has the security setting, the flow enters Step S204 to set a tag to be “inactive” that indicates the current connected access point has the security setting; if the current network connection does not have the security setting, the flow enters Step S206. In Step S206, the wireless network device 100 stores current network connection information, such as service set identifier (SSID) and channel information, into a storage unit (e.g., memory in a Basic Input/Output System (BIOS)). Then, in Step S208, the wireless network driver 124 sets the tag to be “active” that indicates the current connected access point does not have the security setting. Finally, the flow enters Step S210 to finish the above-mentioned network connection checking flow, and the wireless network device 100 enters the sleep mode.

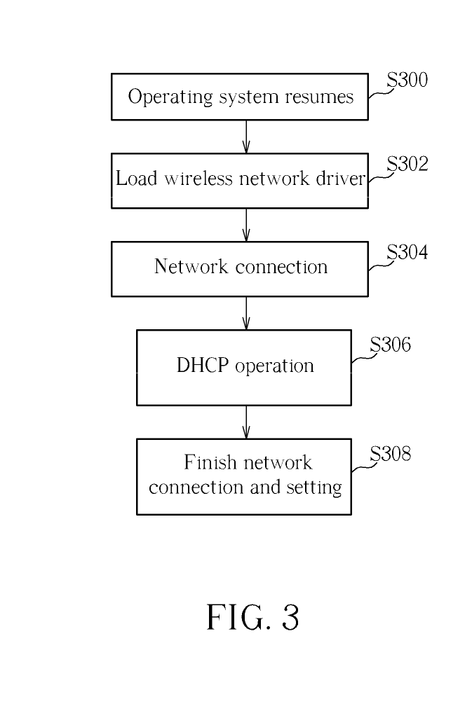

Please refer to FIG. 1 and FIG. 3 together. FIG. 3 is a flowchart of the method for controlling the network connection of the wireless network device 100 after the wireless network device 100 wakes up from the sleep mode according to one embodiment of the present invention. Referring to FIG. 3, the flow is described as follows.

In Step S300, the operating system 122 of the wireless network device 100 resumes. Then, in Step S302, the operating system 122 loads the wireless network driver 124. In Step S304, the wireless network device 100 starts the network connection. Then, in Step S306, the wireless network device 100 performs a dynamic host configuration protocol (DHCP) operation to obtain an IP address. Finally, the flow enters Step S308 to finish the network connection and setting.

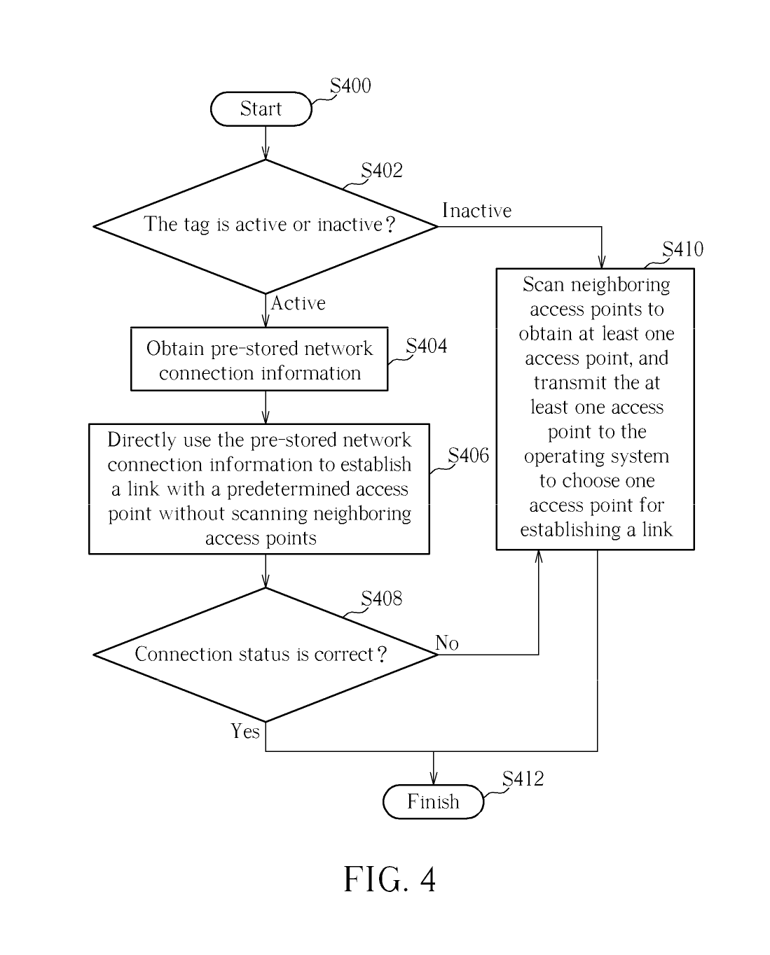

Please refer to FIG. 4, which is a flowchart of a detail of the Step S304. Referring to FIG. 4, the flow is described as follows.

In Step S400, the flow starts. Then, in Step S402, the wireless network driver 124 checks the tag set in Step S204 or Step S208. If the tag is “inactive” (i.e., the previous connected access point has the security setting), the flow enters Step S410; and if the tag is “active” (i.e., the previous connected access point does not have the security setting), the flow enters Step S404. Then, in Steps S404 and S406, the wireless network driver 124 directly obtain the network connection information, which is stored in Step S206, from the storage unit, and directly uses this pre-stored network connection information to establish a link with a predetermined access point without scanning neighboring access points, where the predetermined access point is a last access point connected to the wireless network device 100 before the wireless network device 100 enters the sleep mode. Then, in Step S408, a connection status is checked. If the connection status is correct, the flow enters Step S412 to finish this flow; and if the connection status is incorrect, the flow enters Step S410. In Step S410, the wireless network driver 124 scans the neighboring access points to obtain at least one access point, and transmits the at least one access point to the operating system 122 to choose one access point for establishing a link by the wireless network driver 124. Then, the flow enters Step S412 to finish this flow.

Referring to the flow shown in FIG. 4, when the previous connected access point does not have the security setting, the wireless network driver 124 directly uses the pre-stored network connection information to establish a link under the condition that the wireless network driver 124 does not scan the neighboring access points. The whole flow can be finished within about 0.4 second. Therefore, compared with the prior art 1-8 seconds connection time, the present invention indeed speed up the network connection time after the wireless network device 100 is waked up from the sleep mode.

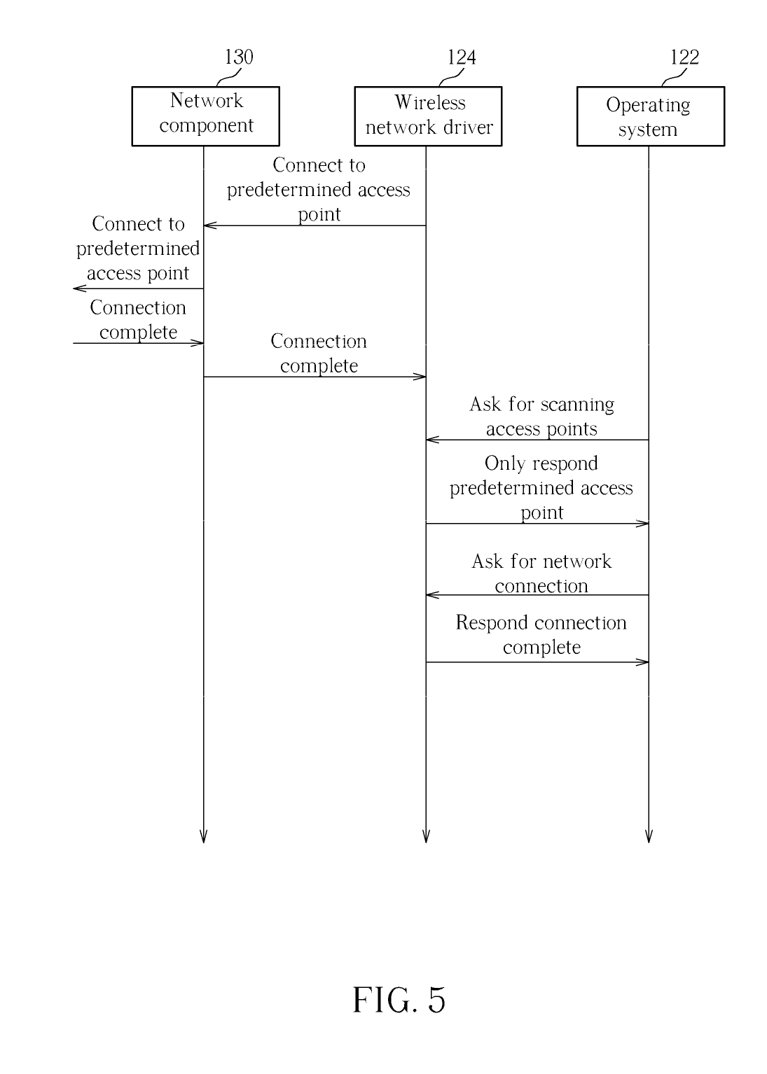

In addition, because the wireless network driver 124 directly uses the pre-stored network connection information to establish a link when the previous connected access point does not have the security setting, later when the operating system 122 transmits a command to the wireless network driver 124 to ask for scanning neighboring access points, the wireless network driver 124 only responds the information of the predetermined access point (i.e., information of the current connected access point) to the operating system 122. In addition, later when the operating system 122 transmits a command to the wireless network driver 124 to ask for establishing a link, the wireless network driver 124 directly responds a connection complete message to the operating system 122. Please refer to FIG. 5, which is a diagram illustrating timing of the above operating steps of the operating system 122, wireless network driver 124 and network component 130.

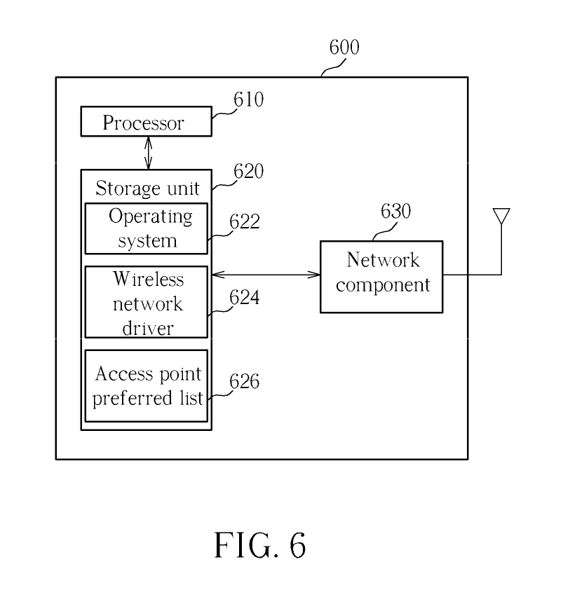

Please refer to FIG. 6, which illustrates a wireless network device 600 according to another embodiment of the present invention. As shown in FIG. 6, the wireless network device 600 includes a processor 610, a storage unit 620 and a network component 630, where the storage unit 620 stores an operating system 622, a wireless network driver 624 and an access point preferred list 626, where the access point preferred list 626 comprises connection records of the wireless network device 600, that is, a plurality of access points connected to the wireless network device 600 before. In addition, in this embodiment, the wireless network device 100 can be a notebook, a tablet computer or any other mobile communication device having wireless network function.

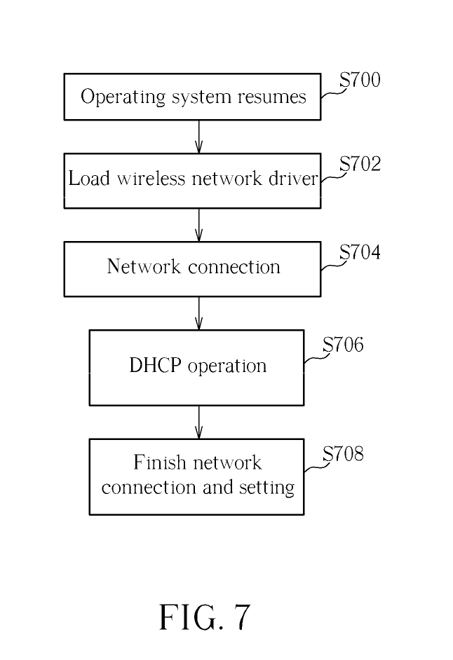

Please refer to FIG. 6 and FIG. 7 together. FIG. 7 is a flowchart of a method for controlling a network connection of the wireless network device 600 according to one embodiment of the present invention. Referring to FIG. 7, the flow is described as follows.

In Step S700, the wireless network device 600 is waked up from a sleep mode, and the operating system 622 resumes. Then, in Step S702, the operating system 622 loads the wireless network driver 624. In Step S704, the wireless network device 600 starts the network connection. Then, in Step S706, the wireless network device 600 performs a dynamic host configuration protocol (DHCP) operation to obtain an IP address. Finally, the flow enters Step S708 to finish the network connection and setting.

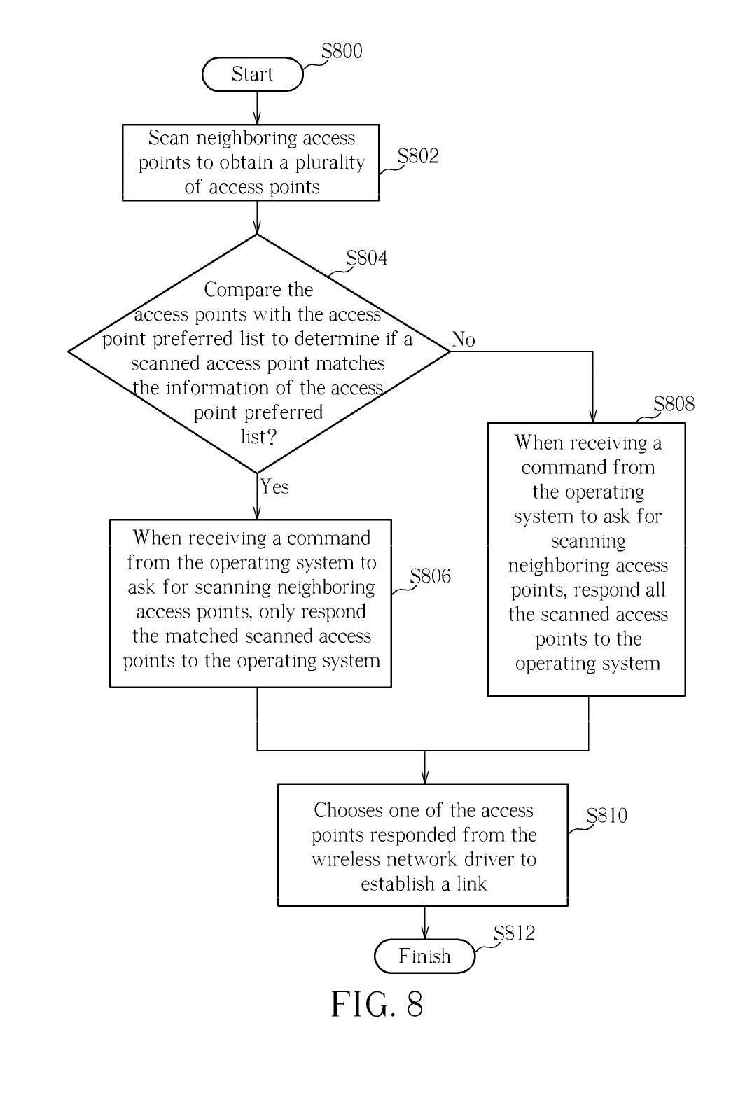

Please refer to FIG. 8, which is a flowchart of a detail of the Step S704. It is noted that, provided the results are substantially the same, the steps are not limited to be executed according to the exact order shown in FIG. 8. Referring to FIG. 8, the flow is described as follows.

In Step S800, the flow starts. Then, in Step 802, the wireless network driver 624 directly scans neighboring access points to obtain information of a plurality of access points. In Step S804, the wireless network driver 624 compares the scanned access points with the access point preferred list 626 to determine if at least a portion of the scanned access points match the information of the access point preferred list 626. If yes, the flow enters Step S705; and if not, the flow enters Step S808. In Step S806, when the wireless network driver 624 receives a command from the operating system 622 to ask for scanning access points, the wireless network driver 624 only responds the portion of the scanned access points to the operating system 622. For example, assuming that ten access points are searched but only two access points are listed in the access point preferred list 626, then the wireless network driver 624 only responds theses two access points to the operating system 622, and does not respond the other eight access points. In Step S808, when the wireless network driver 624 receives a command from the operating system 622 to ask for scanning neighboring access points, the wireless network driver 624 responds all the scanned access points to the operating system 622. Then, in Step S810, the operating system 622 chooses one of the access points responded from the wireless network driver 624 to establish a link. Finally, the flow enters Step S812 to finish the flow.

Referring to the flow shown in FIG. 8, when at least a portion of the scanned access points match the information of the access point preferred list 626, the wireless network driver 624 only responds portion of the scanned access points and does not respond all the scanned access points. Therefore, the operating system 622 needs less time to compare the access points (Step S810). The whole flow can be finished within about 1 second. Therefore, compared with the prior art 1-8 seconds connection time, the present invention indeed speed up the network connection time after the wireless network device 600 is waked up from the sleep mode.

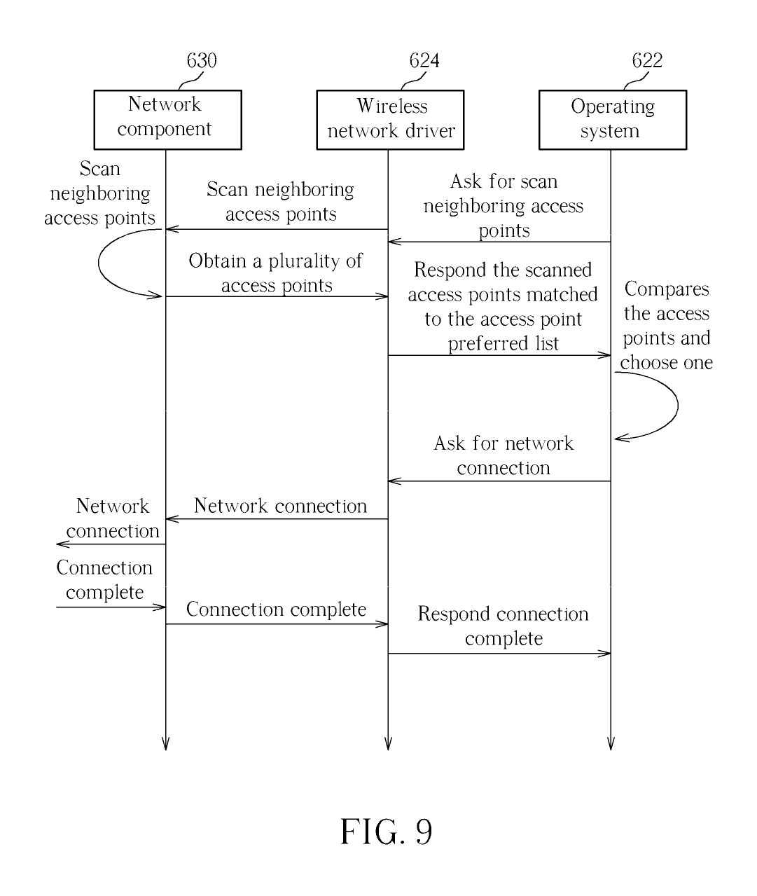

FIG. 9 is a diagram illustrating timing of the above operating steps of the operating system 622, wireless network driver 624 and network component 630.

In addition, in another embodiment of the present invention, the method for controlling the network connection may comprise the flow shown in FIG. 4 and FIG. 8. That is, the Step S802-S810 shown in FIG. 8 can be arranged following the Step S410 shown in FIG. 4. Because a person skilled in this art should understand how to combine the embodiments of FIG. 4 and FIG. 8 after reading the above-mentioned disclosure, further descriptions are omitted here.

Briefly summarized, in the method for controlling a network connection of a wireless network device and associated wireless network device of the present invention, the wireless network driver can directly use the information of the previous connected access point to establish a link under the condition that the wireless network driver does not scan access points, or the wireless network driver can respond only a portion of access points to the operating system to decrease the loading of the operating system. Therefore, the wireless network device can quickly establish a link after being waked up from a sleep mode, and the user can use the network without waiting a long time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a network connection of a wireless network device, comprising:
after the wireless network device is waked up from a sleep mode:
loading a wireless network driver;
determining whether a predetermined access point satisfies a predetermined rule under a condition that the wireless network driver does not scan access points; and
when the predetermined access point satisfies the predetermined rule, the wireless network driver directly utilizes pre-stored network connection information to connect to the predetermined access point without scanning the access points.

2. The method of claim 1, further comprising:
when the predetermined access point does not satisfy the predetermined rule, the wireless network driver scans the access points to obtain at least one access point, an operating system receives the at least one access point and choose one access point, and the operating system sends the chosen access point to the wireless network driver to establish a link.

3. The method of claim 1, further comprising:
before the wireless network device enters the sleep mode:
storing information of a current network connection of the wireless network device as the pre-stored network connection information;
wherein the current network connection is a last network connection of the wireless network device before the wireless network device enters the sleep mode.

4. The method of claim 3, further comprising:
before the wireless network device enters the sleep mode:
setting a tag according to the current network connection of the wireless network device and the predetermined access point, wherein the tag is utilized to represent whether the predetermined access point has a security setting or not;
wherein the predetermined rule is that the predetermined access point does not have the security setting.

5. The method of claim 1, further comprising:
after the wireless network device is waked up from the sleep mode:
receiving a command from an operating system to ask for scanning the access points; and
when the predetermined access point satisfies the predetermined rule, and after the wireless network driver directly utilizes the pre-stored network connection information to connect to the predetermined access point, the wireless network driver only responds the predetermined access point to the operating system.

6. A wireless network device, comprising:
a storage unit, for storing an operating system and a wireless network driver; and
a network component;
wherein after the wireless network device is waked up from a sleep mode, the operating system resumes and loads the wireless network driver; the wireless network driver determines whether a predetermined access point satisfies a predetermined rule under a condition that the wireless network driver does not scan access points; and when the predetermined access point satisfies the predetermined rule, the wireless network driver directly utilizes pre-stored network connection information to connect to the predetermined access point via the network component without scanning the access points.

7. The wireless network device of claim 6, wherein when the predetermined access point does not satisfy the predetermined rule, the wireless network driver scans the access points to obtain at least one access point, an operating system receives the at least one access point and choose one access point, and the operating system sends the chosen access point to the wireless network driver to establish a link.

8. The wireless network device of claim 6, wherein before the wireless network device enters the sleep mode, the wireless network driver stores information of a current network connection of the wireless network device as the pre-stored network connection information, wherein the current network connection is a last network connection of the wireless network device before the wireless network device enters the sleep mode.

9. The wireless network device of claim 8, wherein before the wireless network device enters the sleep mode, the wireless network driver sets a tag according to the current network connection of the wireless network device and the predetermined access point, wherein the tag is utilized to represent whether the predetermined access point has a security setting or not, and the predetermined rule is that the predetermined access point does not have the security setting.

10. The wireless network device of claim 6, wherein after the wireless network device is waked up from the sleep mode, the wireless network driver receives a command from an operating system to ask for scanning the access points; and when the predetermined access point satisfies the predetermined rule, and after the wireless network driver directly utilizes the pre-stored network connection information to connect to the predetermined access point, the wireless network driver only responds the predetermined access point to the operating system.

11. A method for controlling a network connection of a wireless network device, comprising:
after the wireless network device is waked up from a sleep mode:
loading a wireless network driver;
scanning neighboring access points to obtain a plurality of access points by the wireless network driver;
comparing the plurality of access points with an access point preferred list by the wireless network driver;
when the wireless network driver receives a command from an operating system to ask for scanning the neighboring access points, and at least a portion of access points are in the access point preferred list, only responding the portion of access points to the operating system by the wireless network driver; and
choosing one access point among the portion of access points, and sending the chosen access point to the wireless network driver by the operating system to establish a link.

12. The method of claim 11, further comprising:
when none of the plurality of access points is in the access point preferred list, responding all the plurality of access points to the operating system by the wireless network driver.

13. The method of claim 11, further comprising:
before the wireless network device enters the sleep mode, creating the access point preferred list according to a plurality of connection records of the wireless network device.

14. A wireless network device, comprising:
a storage unit, for storing an operating system and a wireless network driver; and
a network component;
wherein after the wireless network device is waked up from a sleep mode, the operating system loads a wireless network driver; the wireless network driver scans neighboring access points to obtain a plurality of access points; the wireless network driver compares the plurality of access points with an access point preferred list; when the wireless network driver receives a command from an operating system to ask for scanning the neighboring access points, and at least a portion of access points are in the access point preferred list, the wireless network driver only responds the portion of access points to the operating system; and the operating system chooses one access point among the portion of access points, and sends the chosen access point to the wireless network driver to establish a link via the network component.

15. The wireless network device of claim 14, wherein when none of the plurality of access points is in the access point preferred list, the wireless network driver responds all the plurality of access points to the operating system.

16. The wireless network device of claim 14, wherein before the wireless network device enters the sleep mode, the wireless network driver creates the access point preferred list according to a plurality of connection records of the wireless network device.
